(19) United States
(12) Patent Application Publication
(10) Pub. No.: US 2022/0138283 A1
(43) Pub. Date: May 5, 2022

(54) Secure Content Access

(71) Applicant: Comcast Cable Communications, LLC, Philadelphia, PA (US)

(72) Inventors: Nikola Kolev, Philadelphia, PA (US); Kyong Park, Woodbine, MD (US); Benjamin E. Greenberg, Philadelphia, PA (US)

(21) Appl. No.: 17/085,313

(22) Filed: Oct. 30, 2020

(51) Int. Cl. G06F 21/10; H04L 29/06; H04N 21/4627

(52) U.S. Cl. CPC G06F 21/10; H04N 21/4627; H04L 63/0807; H04L 63/0428

(57) ABSTRACT

Systems, apparatuses, and methods are described for causing output of content via an output device such as a casting device. The output device may be associated with a device identity token indicating an identity for the output device. Another computing device may obtain, based on the device identity token, an output authorization token indicating a content item and the identity of the output device. The output device may, based on the output authorization token, obtain authorization data for output of the content item.

### BACKGROUND

In an output method sometimes referred to as casting, a first device such as a smart phone, tablet computer, or other type of device may instruct a separate casting device to cause output of a particular content item. The casting device may receive media data for that content item and cause output of the content item (e.g., via a display device to which the casting device is connected). To prevent unauthorized access to content, a casting device may store data that can be provided to establish that the casting device is authorized to access content. However, such data may be intercepted or otherwise obtained and copied to unauthorized devices.

### SUMMARY

The following summary presents a simplified summary of certain features. The summary is not an extensive overview and is not intended to identify key or critical elements.

Systems, apparatuses, and methods are described for causing output of content and/or preventing unauthorized devices from accessing content. An output device, for example, a casting device, may receive a device identity token. That device identity token may be associated with a unique identity for the output device. A second device (e.g., a smart phone, tablet, or other user device) may receive a request to cause output of a content item via the output device. Based on the device identity token for the output device, the second device may obtain an output authorization token that may indicate a binding of the content item and of an identity of the output device. The output device may, based on the output authorization token, obtain digital rights management (DRM) data for accessing the content item.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows example hardware elements of a computing device.

FIGS. 3A and 3B show communications and/or steps in one or more example methods associated with output of a content item.

FIG. 4 is a diagram showing examples of features that may be comprised by one or more of the communications and/or steps shown in FIGS. 3A and 3B.

FIG. 5 is a diagram showing additional examples of features that may be comprised by one or more of the communications and/or steps shown in FIGS. 3A and 3B.

FIGS. 6A and 6B are a flow chart showing steps of an example method associated with output of a content item.

FIG. 7 is a flow chart showing steps of an example method associated with output of a content item.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

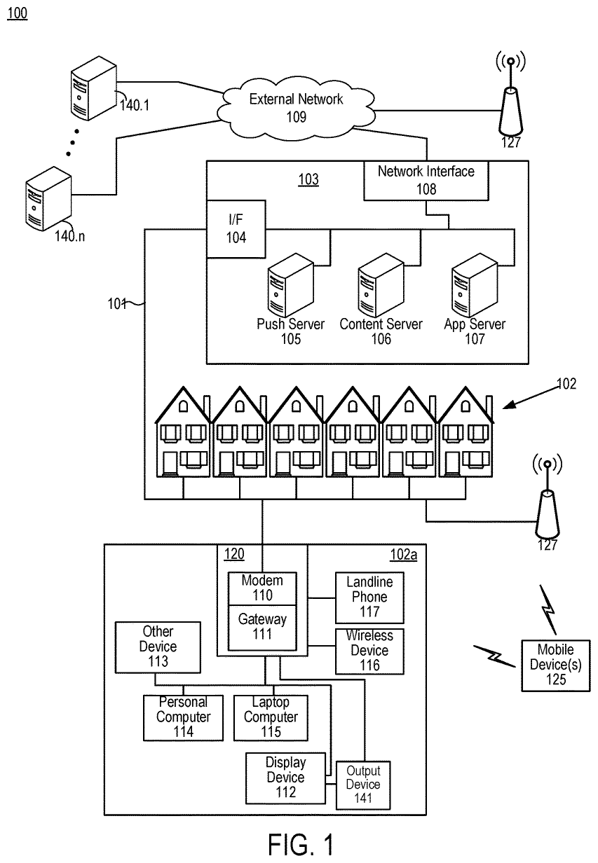

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers in communication with other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (and/or an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Also or alternatively, one or more servers 140.1 through 140.n may be part of the external network 109 and may be configured to communicate (e.g., via the local office 103) with computing devices located in or otherwise associated with one or more premises 102. Although shown separately, the push server 105, the content server 106, the application server 107, the servers 140.1-140.n, and/or other server(s) may be combined. The servers 105, 106, 107, 140.1-140.n, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g. Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises. The computing devices in the premises 102a may comprise an output device 141, which is further described below.

The mobile devices 125, one or more of the devices in the premises 102a, and/or other devices may receive, store, output, process, and/or otherwise use data associated with content items. A content item may comprise a video, a game, one or more images, software, audio, text, webpage(s), and/or other type of content. One or more types of data may be associated with a content item. A content item may, for example, be associated with media data (e.g., data encoding video, audio, and/or images) that may be processed to cause output of the content item via a display screen, a speaker, and/or other output device component. A content item may, for example, be associated with metadata (e.g., descriptive information, file name and/or location, digital rights management (DRM) information, etc.).

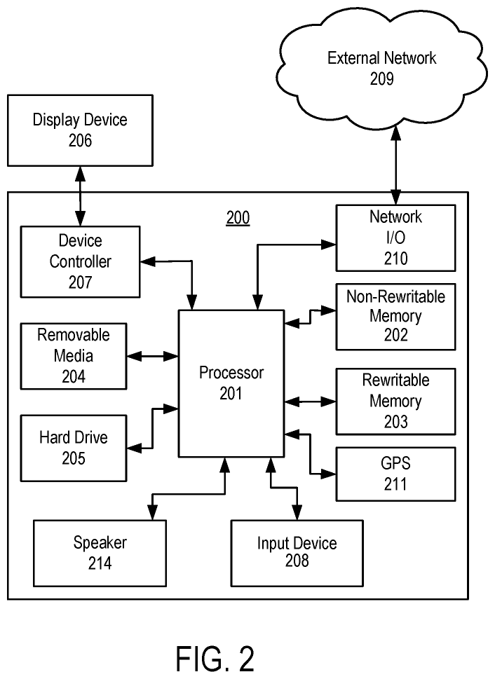

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices that are part of or associated with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output components, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

A computing device 200 may also include a secure element. The secure element may include device-specific computer-executable instructions to perform actions associated with digital rights management (DRM). The secure element may be included as part of the non-rewriteable memory 202. Alternatively or additionally, the secure element may comprise hardware circuitry (e.g., a separate chip) of the computing device 200 (not shown). The secure element may comprise device-specific identity information, such as, for example, a media access control (MAC) address. The secure element may include encryption information for use with DRM licenses required to output content. For example, the secure element may comprise public/private key cryptography information. Output of content may, for example, comprise output of audio (e.g., via one or more speakers) and/or video (e.g., via one or more display devices), may comprise output (e.g., to one or more computing devices and/or computing device components) of media data and/or other data associated with content, and/or may comprise one or more other types of output.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

The output device 141 shown in FIG. 1 may comprise a casting device and/or other type of computing device that may be configured to cause output of content items. A computing device in the premises 102a that is separate from the output device 141, for example, the wireless device 116, the personal computer 114, the laptop computer 115, etc., may communicate (e.g., via a wired or wireless network of the premises 102a) with the output device 141 to instruct or otherwise cause the output device 141 to initiate output. The output device 141 may receive, independently of the separate computing device that instructed or otherwise caused initiation of output, media data and/or other data associated with the content item. The output device 141 may process that media data and/or other data to cause output (e.g., via another computing device with which the output device is in communication) of the content item. The separate computing device that instructed or otherwise caused output initiation may communicate other instructions to the output device 141 relating to output (e.g., to stop output, to pause, to rewind, to fast forward, etc.). The output device 141 may be configured to communicate (e.g., with the separate computing device that instructed or otherwise caused output initiation) using a casting protocol (e.g., the GOOGLE CAST casting protocol).

An output device may be a separate computing device that is in communication with a computing device (e.g., the display device 112) via which the output device causes output of a content item. Examples of such output devices include, without limitation, GOOGLE CHROMECAST streaming devices, AMAZON FIRE TV streaming devices, APPLE TV streaming devices, ROKU streaming devices, etc. An output device may be a type of user device. An output device need not be separate from a computing device via which a content item is output. For example, an output device may comprise a computing device (e.g., tablet computing device) having a display screen and/or speakers via which the output device may cause output of a content item.

An output device (e.g., a casting device) may be associated with a service (e.g., a casting service) that provides (e.g., for a fee) access to content via the output device. Entitlement data, which may also be associated with the service, with one or more users, and/or with one or more user devices, may indicate content items that may be accessed via the service, users and/or devices entitled to access various content items via the service, limitations on a quantity of users and/or devices that may access content via the service, limitations on times when various content items may be accessed, and/or other limitations, rules, etc. for accessing content via the service. To prevent unauthorized accessing of content, an output device may be provided with a data element that indicates the output device is permitted to access content. That data element may be provided in connection with requesting access to a content item via the service. Based on that data element, one or more servers or other computing devices (e.g., associated with and/or acting on behalf of the service) may determine whether the output device is permitted to access content.

However, such data elements may be subject to malicious attack and/or may be misappropriated for use by unauthorized devices and/or users. In a man-in-the-middle attack, for example, a malicious user may sniff or otherwise monitor network traffic and detect a data element being provided to an output device that is entitled to access content. The malicious user may, in a process known as side-loading, copy that data element to an unauthorized device that is not entitled to access content. The unauthorized device may be able, by providing the side-loaded data element, to obtain content without having legitimate authorization to do so.

To reduce and/or prevent such attacks and/or misuse, and as described herein, an output authorization token may be associated with a specific output device, and/or may bind an identity of the specific device with a content item. If that output authorization token is somehow sideloaded into an unauthorized device, the use of that token by an unauthorized device may be detected and access to the content item may be denied. Content item access may be denied by, for example, denying DRM data that would allow access to decryption keys for media data associated with the content item. To associate an output authorization token with a specific device, that device may be provided (e.g., by and/or on behalf of a DRM service provider) with a device identity token. An output authorization token may be provided to an output device based, for example, on that output device providing a device identity token.

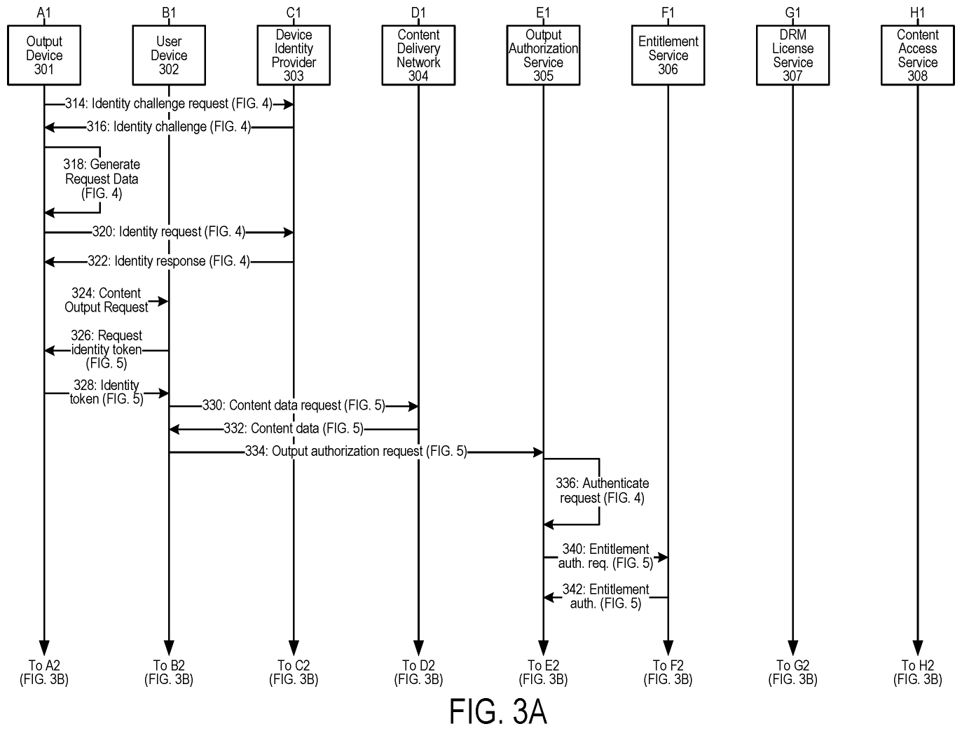

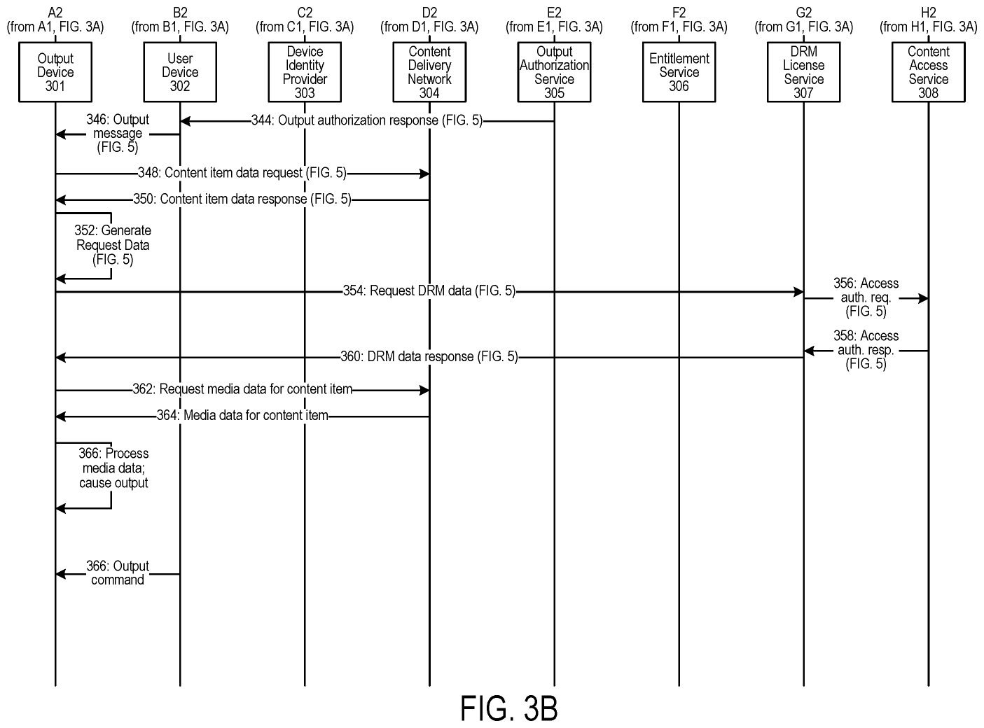

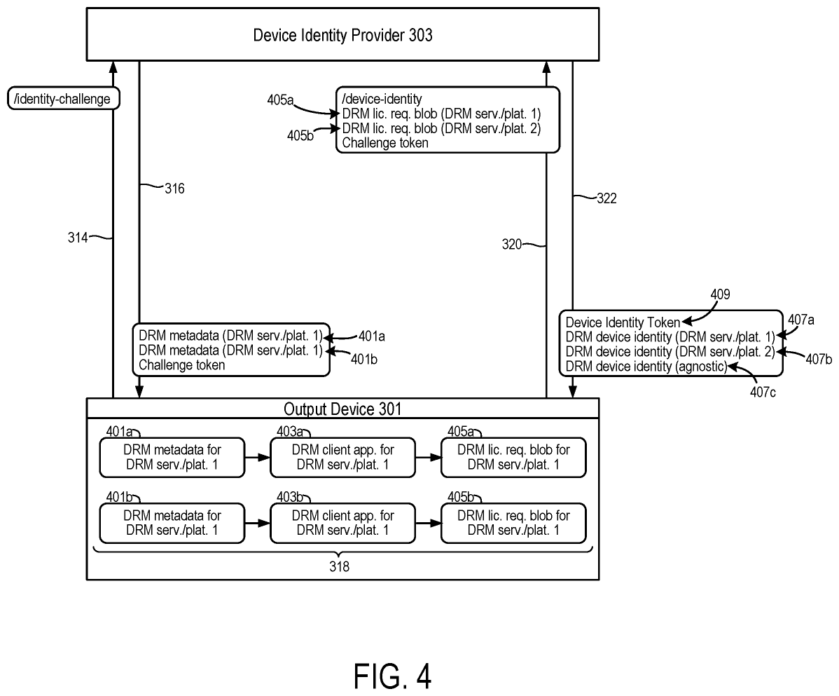

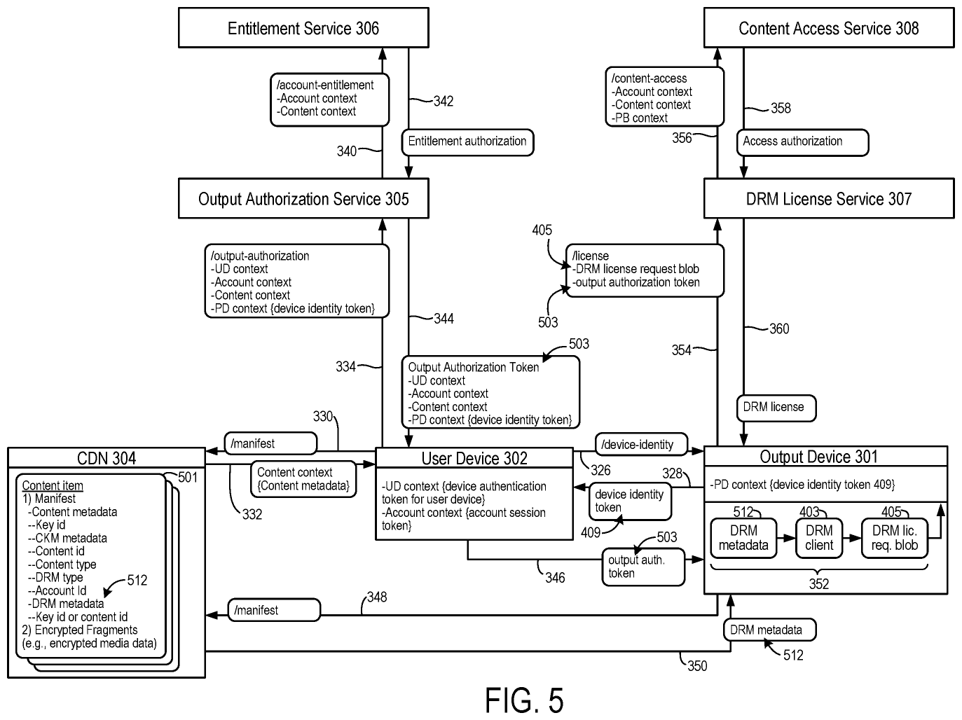

FIGS. 3A and 3B are a diagram showing communications and/or steps in one or more example methods associated with output of a content item via an output device. FIG. 3B is a continuation of FIG. 3A, as indicated at the bottom of FIG. 3A and at the top of FIG. 3B. FIGS. 4 and 5 are diagrams showing examples of features that may be comprised by one or more of the communications and/or steps shown in FIGS. 3A and 3B. The devices shown in FIGS. 3A-5 may be configured (e.g., based on stored instructions) to perform operations such as are described herein.

Output device 301 may comprise the output device 141 and/or another computing device.

Vertical lines Al (FIG. 3A) and A2 (FIG. 3B) correspond to the output device 301. User device 302 may comprise a computing device that communicates with the output device 301 to, for example, initiate and/or control output of content via the output device 301. The user device 302 may comprise the wireless device 116, the personal computer 114, the laptop computer 115, and/or another computing device. Vertical lines B1 (FIG. 3A) and B2 (FIG. 3B) correspond to the user device 302.

The device identity provider 303 may comprise one or more servers (e.g., one or more of the servers 105, 106, 107, 140.1-140.n, etc.) and/or other computing devices that determine whether to provide, and/or that provide, device identity tokens. An output device, for example, the output device 301, may interact with the device identity provider 303 to acquire or renew a device identity token. The device identity provider 303 may, for example, be operated by (and/or on behalf of, with the authorization of, and/or otherwise in association with) one or more DRM service providers. Vertical lines C1 (FIG. 3A) and C2 (FIG. 3B) correspond to the device identity provider 303.

The content delivery network 304 may comprise one or more servers (e.g., one or more of the servers 105, 106, 107, 140.1-140.n, etc.) and/or other computing devices that provide data for content items. That data may include media data, metadata, manifest files, and/or other types of data. The content delivery network 304 may, for example, be associated with a casting service provider and/or another service provider that makes content items available to authorized devices and/or users. Vertical lines D1 (FIG. 3A) and D2 (FIG. 3B) correspond to the content delivery network 304.

The output authorization service 305 may comprise one or more servers (e.g., one or more of the servers 105, 106, 107, 140.1-140.n, etc.) and/or other computing devices that provide output authorization tokens. The output authorization service 305 may, for example, be associated with a casting service provider and/or another service provider that makes content items available to authorized devices and/or users. Vertical lines E1 (FIG. 3A) and E2 (FIG. 3B) correspond to the output authorization service 305.

The entitlement service 306 may comprise one or more servers (e.g., one or more of the servers 105, 106, 107, 140.1-140.n, etc.) and/or other computing devices that are configured to access entitlement data (e.g., data for an account associated with the output device 301, the user device 302, a user of the output device 301 and/or of the user device 302, etc.) and determine if an output authorization token may be provided to a particular output device and/or with regard to a particular content item. Vertical lines F1 (FIG. 3A) and F2 (FIG. 3B) correspond to the entitlement service 306.

The DRM license service 307 may comprise one or more servers (e.g., one or more of the servers 105, 106, 107, 140.1-140.n, etc.) and/or other computing devices that are configured to determine whether DRM data should be provided to allow access to a particular content item. The computing device(s) of the DRM license service 307 may be operated by (and/or on behalf of, with the authorization of, and/or otherwise in association with) one or more DRM service providers. DRM data (e.g., a DRM license) may comprise authorization data that allows a device (e.g., the output device 301) to access one or more decryption keys needed to decrypt encrypted media data for a content item. For example, prior to distribution, media data for a content item may be encrypted using one or more first encryption keys. To output video, audio, and/or other media for the content item, the encrypted media data may be decrypted using one or more first decryption keys. A DRM service provider may provide a DRM service that may comprise protecting those first decryption keys by adding one or more layers of additional encryption (e.g., wrapping) of those first decryption keys, providing DRM data to access those first decryption keys, determining whether and/or to whom (and/or to what device) DRM data should be provided, etc. DRM data may comprise second keys that may be used to decrypt first decryption keys usable to decrypt encrypted media data. A DRM service of a DRM service provider may comprise and/or otherwise be associated with a DRM platform, which may comprise client software for interacting with the DRM service, communication specifications and/or protocols used by the DRM service, encryption and/or other security specifications and/or protocols used by the DRM service, etc. Examples of DRM services/platforms comprise WIDEVINE content protection (provided by Google, LLC), PLAYREADY media protection technology (provided by Microsoft Corporation), and FAIRPLAY DRM (provided by Apple, Inc.). The DRM license service 307 may be associated with a single DRM service/platform, or may be associated with multiple DRM services/platforms. Vertical lines G1 (FIG. 3A) and G2 (FIG. 3B) correspond to the DRM license service 307.

The content access service 308 may comprise one or more servers (e.g., one or more of the servers 105, 106, 107, 140.1-140.n, etc.) and/or other computing devices that are configured to determine whether access to a content item should be permitted. For example, an output device may possess a valid output authorization token and be authorized to view certain content, but access to a particular content item may be limited to a particular region, to particular times, to a maximum quantity of concurrent accesses, and/or on some other basis. Vertical lines H1 (FIG. 3A) and H2 (FIG. 3B) correspond to the content access service 308.

One or more of the computing devices shown in FIGS. 3A-5 may be combined or omitted, and/or additional computing devices may be added. The communications and steps shown in FIGS. 3A-5 need not be performed in the order shown and/or may be sent by, received from, or performed by different computing devices. One or more of those communications and/or steps may be combined, omitted, or modified, and/or other steps and/or communications may be added. A request, response, and/or other communication shown in, and/or described in connection with, FIGS. 3A-5 need not be a single message nor contained in a single packet, block, or other transmission unit.

In step 314, and as part of obtaining or renewing a device identity token, the output device 301 may send an identity challenge request to the device identity provider. The identity challenge request of step 314 may, for example, comprise a hypertext transfer protocol (HTTP) GET method. The identity challenge request may be associated with a path (e.g., “/identity-challenge” as shown in FIG. 4).

A device identity token may comprise data that indicates (e.g., claims) one or more identities of an output device. The indicated identities may comprise separate identities for the output device for separate DRM services/platforms supported by the device, and/or may comprise an identity for the output device that is agnostic to any specific DRM service/platform. A device identity token may be cryptographically secure. A cryptographically secure token (e.g., a device identity token and/or other tokens described herein) may be digitally signed (e.g., by an issuer of the token). A digital signature may comprise, for example, a hash of a token (or a portion thereof, and/or of data related to a token) generated using a predefined algorithm and/or using one or more encryption keys. An entity receiving the token may verify that the token is unaltered (and/or was created by a known source) by recreating the digital signature using the predefined algorithm and an appropriate key (e.g., a public key corresponding to a private key of the token issuer) and comparing that recreated digital signature to the digital signature received with the token. Also or alternatively, a cryptographically secure token may be encrypted, and the token may be verified by successfully decrypting the token.

In step 316, and based on receiving the identity challenge request in step 314, the device identity provider 303 may send an identity challenge. The identity challenge may comprise DRM metadata associated with one or more DRM services/platforms. For example, and as shown in FIG. 4, the identity challenge of step 316 may comprise DRM metadata 401a for a first DRM service/platform (DRM serv./plat. 1), DRM metadata 401b for a second DRM service/platform (DRM serv./plat. 2), and/or for one or more other services/platforms. DRM metadata for a particular DRM service/platform may comprise signaling data that is configured for input into a DRM client application executing on an output device, as described below. The DRM metadata may comprise information indicating a DRM service/platform, information indicating a time/date, information indicating a service provider (e.g., a content provider), information indicating one or more content items, nonce values and/or other values generated for identification purposes, and/or other data. Each DRM service/platform may specify its own requirements for DRM metadata.

The identity challenge of step 316 may also comprise a challenge token. The challenge token may be used, for example, to prevent replay attacks and/or other malicious activity. The identity challenge may include a digital signature. The digital signature may comprise a digest (e.g., an SHA (secure hashing algorithm)-256 hash over the entire response body). The response body may comprise, for each supported DRM service/platform, a license service certificate and DRM metadata.

In step 318 (FIG. 3A), the output device 301 may generate request data. For each DRM service/platform supported by the output device 301, the output device 301 may execute a DRM client application. In the example of FIG. 4, the output device 301 may execute a client application 403a for the first DRM service/platform (DRM serv./plat. 1) and a client application 403b for the second DRM service/platform (DRM serv./plat. 2). Each of the applications 403a and 403b may receive DRM metadata as an input and may generate, based on that input DRM metadata and on one or more hardware identifiers associated with the output device 301 (e.g., an identifier associated with a security chip or other secure element, a MAC address of a network interface, a processor hardware identifier, a RAM hardware identifier, a BIOS hardware identifier, etc.), DRM license request data in the form of a binary large object (blob). A DRM license request blob may be digitally signed (e.g., using a hashing algorithm and/or keys of the DRM client application that are known to the DRM service/platform corresponding to that DRM client application). Also or alternatively, a DRM license request blob may be encrypted and/or otherwise unreadable (e.g., because a generation algorithm used by a DRM client application may not be exposed) by entities other than the corresponding DRM service/platform. In the example of step 318, the DRM client 403a processes the DRM metadata 401a and generates the DRM license request blob 405a, and the DRM client 403b processes the DRM metadata 401b and generates the DRM license request blob 405b. A DRM license request blob may indicate a unique identity (e.g., based on one or more hardware identifiers) of the device that generated the DRM license request blob. In the example of FIG. 4, each of the DRM license request blobs 405a and 405b may indicate a unique device identity for the output device 301 that is based on the one or more hardware identifiers used by the client applications 403a and 403b to generate the DRM license request blobs 405a and 405b. The indications of identity of the output device 301 in the device the DRM license request blobs 405a and 405b may be cryptographically secure, and/or otherwise verifiable, based on digital signatures and/or encryption of the DRM license requests blobs and/or based on the DRM license request blobs being otherwise unreadable by entities other than the corresponding DRM services/platforms.

In step 320 (FIG. 3A), the output device 301 may send a device identity request to the device identity provider 303. The device identity request may comprise the DRM license request blobs generated in step 318. In the example of FIG. 4, the device identity request may comprise the DRM license request blobs 405a and 405b. The device identity request may also include the challenge token received in step 316. If steps 314, 316, 318, and 320 are being performed to renew a previously issued device identity token, that token may also be included in the device identity request. The device identity request of step 320 may, for example, comprise a hypertext transfer protocol (HTTP) POST method. The identity request may be associated with a path (e.g., “/device-identity” as shown in FIG. 4).

The device identity provider 303 may process each of the DRM license request blobs, received in the identity request of step 320, to determine the unique device identity of the output device 301 for the corresponding DRM services/platforms. If the identity request of step 320 included a previously-issued device identity token, the device identity provider 303 may authenticate that token and may discover DRM system/platform-agnostic and/or DRM system/platform-specific identities that the output device 301 was previously bound to. The device identity provider 303 may deny renewal of a DRM system/platform-agnostic identity (e.g., if an existing device identity token received in step 320 does not match any DRM system/platform-specific identities determined based on the received DRM license request blobs) and generate a new DRM system/platform-agnostic identity.

In step 322 (FIG. 3A), the device identity provider 303 may (e.g., based on processing each of the DRM license request blobs received in the identity request of step 320) send an identity response comprising a device identity token 409 to the output device 301. The device identity token 409 may be cryptographically secure and may indicate (e.g., claim) DRM system/platform-specific identities and/or DRM system/platform-agnostic identities for the output device 301. The response of step 322 may indicate whether a DRM system/platform-agnostic identity was renewed or whether a new DRM system/platform-agnostic identity was generated. In the example of FIG. 4, the identity response of step 322 may comprise a device identity token 409 indicating DRM system/platform-specific identities 407a (for the first DRM service/platform) and 407b (for the second DRM service/platform) and DRM system/platform-agnostic identity 407c. The response of step 322 may be include a digital signature (e.g., a digest such as an SHA-256 hash over the response body). The output device 301 may store the device identity token 409 received in step 322 for use in connection with output requests.

In step 324 (FIG. 3A), the user device 302 may receive a request for output of a content item via the output device 301. The request of step 324 may comprise, for example, an input to an application executing on the user device 302. That application may be configured to communicate with the output device 301 and may be associated with a content provider that provides content items to authorized devices. That application, and/or the content provider, may be associated with the output device 301.

In step 326, based on the request for output of the content item, the user device 302 may send, to the output device 301, a request for a device identity token. Because the output device 301 previously obtained the device identity token 409 in steps 314-322, the output device 301 sends, to the user device 302 and based on the request of step 324, the device identity token 409 (step 328). If the output device 301 had not already performed steps 314-322 to obtain the device identity token 409, the output device may, based on receiving the request of step 326, perform steps 314-322 to obtain a device identity token prior to performing step 328.

In step 330, the user device 302 may send a content data request to the content delivery network 304. The request of step 330, which may be associated with a path (e.g., “/manifest”, as shown in FIG. 5), may request a manifest and/or other content metadata for a content item 501. The content item 501 may be a content item that was indicated by the request of step 324. In step 332, and based on the request of step 330, the content delivery network 304 may send, to the user device 302, content metadata comprising one or more of: one or more key identifiers, content key management (CKM) metadata, one or more content identifiers, one or more indications of content type, one or more indicators of DRM service/platform, one or more account identifiers, DRM metadata 512, and/or other information. The DRM metadata 512 sent in step 332 may be different from the DRM metadata sent in step 316 and may, for example, comprise data indicating and/or otherwise associated with a DRM service/platform, data (e.g., a content id) indicating the content asset 501, one or more key identifiers and/or other indicators of one or more keys (e.g., Key id), and/or other data.

In step 334, and based on the content metadata received in step 332 and the device identity token 409 received in step 328, the user device 302 may send an output authorization request to the output authorization service 305. The output authorization request may comprise, for example, an HTTP POST method and/or may be associated with a path (e.g., “/output-authorization”). The output authorization request of step 334 may be digitally signed and/or otherwise authenticatable based on an identity of the user device 302. The output authorization request may comprise user device context, account context, content context, output device context, and/or other data. The user device context may comprise a cryptographically secure device authentication token for the user device 302. For example, the user device 302 may have previously obtained (e.g., using a secure hardware element and/or software executing on the user device 302) that token during authentication and/or set-up of the user device 302. The account context may comprise a cryptographically secure account session token obtained during set-up, by the user device 302, of a current session for an account associated with the user device 302. The content context may comprise the CKM metadata and/or other data from, or based on, the content metadata received in step 332. The output device context may comprise the device identity token 409, of the output device 301, received in step 328. The output authorization request may be authenticatable based on one or more of the user device context, the account context, and/or other digital signature and/or encryption.

Based on the output authorization request received in step 334, the output authorization service 305 may authenticate the output authorization request (e.g., based on the user device context and/or the account context), and may also authenticate the device identity token 409 of the output device 301. Also or alternatively, the output authorization service 305 may, based on the output authorization request, perform an entitlement check to determine whether the output device 301 and/or the user device 302 is entitled to receive the content item 501 (e.g., whether the content item 501 is available based on a subscription associated with an account). To perform the entitlement check, in step 340 the output authorization service 305 may send, to the entitlement service 306, an entitlement authorization request. The entitlement authorization request may comprise the account context and/or the content context received in the output authorization request of step 334, and/or may comprise other data. The entitlement authorization request may comprise an HTTP method (e.g., POST) associated with a path (e.g., “/account-entitlement”). The entitlement service 306 may, based on the entitlement authorization request, verify the account context, the content context, and/or other information from the entitlement authorization request and may determine (e.g., based on account data stored in one or more databases) whether the output device 301 and/or the user device 302 is entitled to receive the content item 501. Based on determining that such entitlement exists, the account entitlement service 306 may return entitlement authorization to the output authorization service 305 (step 342).

If the output authorization service 305 is unable to authenticate or otherwise process the output authorization request (or a part thereof), and/or if the entitlement check fails, the output authorization service may send a denial to the user device 302. Such a denial, which may include a code indicating the reason for denial, may cause the user device 302 and/or the output device 301 to cause output of a display indicating the denial, the reason for the denial, and/or corrective actions that may be taken. Otherwise, and based on successful authentication of the output authentication request and/or the entitlement check succeeding (e.g., based on receiving the entitlement authorization), the output authorization service 305 may, in step 344 (FIG. 3B) send an output authorization token 503 to the user device 302. The output authorization token 503 may be cryptographically secure and may indicate (e.g., claim) and/or otherwise be bound to the identity of the output device 301, the identity of the user device 302, the content item 501, and/or the session of the user device 302. For example, and as shown in FIG. 5, the output authorization token 503 may comprise the output device context (e.g., the device identity token 409 for the output device 301), the content context (e.g., the CKM metadata and/or other data from, or based on, the content metadata), the account context (e.g., the account session token), and/or the user device context (e.g., the device authentication token for the user device 302) included in the output authorization request of step 334.

Based on receiving the output authorization token 503 in step 344, the user device may send the output authorization token 503 to the output device 301 (step 346). In step 348, based on receiving the output authorization token 503, the output device 301 may send a request to the content delivery network 304. The request of step 348 may be associated with a path (e.g., “/manifest”), may request DRM metadata 512 associated with the content item 501, and/or may request other data in the manifest for the content item 501. Based on the request of step 348, the content delivery network 304 may in step 350 send the DRM metadata 512 (and/or other data in the content manifest for the content item 501) to the output device 301.

In step 352, and based on receiving the data sent in step 350, the output device 301 may generate a DRM license request blob. The generation of the DRM license request blob generated in step 352 may be similar to the generation DRM request data in step 318. For example, based on the DRM metadata 512, the output device 301 may determine a client application 403 that is executing on the output device 301 and that corresponds to the DRM metadata 512. For example, if the DRM metadata 512 indicates a DRM service/platform also indicated by the DRM metadata 401a (DRM serv./plat. 1), the output device 301 may determine the client application 403a. Similarly, if the DRM metadata 512 indicates a DRM service/platform also indicated by the DRM metadata 401b (DRM sere./plat. 2), the output device 301 may determine the client application 403b. Using the determined DRM client application 403, the output device 301 may generate the DRM license request blob 405. The generation of the DRM license request blob 405 may be based on the DRM metadata 512, on one or more hardware identifiers associated with the output device 301, and/or on data (e.g., received in the message 350 and/or in the message 346) indicating the content item 501. The DRM license request blob 405 may, similar to the DRM license request blob 405a or 405b, indicate a unique identity of the output device 301. The DRM license request blob 405 may also indicate the content item 501. The indications in the DRM license request blob 405 of the unique identity of the output device 301 and/or of the content item 501 may be cryptographically secure, and/or otherwise verifiable, based on a digital signature and/or encryption of the DRM license requests blob 405 and/or based on the DRM license request blob 405 being otherwise unreadable by entities other than the corresponding DRM service/platform.

In step 354, the output device 301 may, based on the data received in steps 346 and/or 350 and/or based on the DRM license request blob 405, send a DRM data request to the DRM license service 307. The DRM data request of step 354 may comprise the DRM license request blob 405 and the output authorization token 503. The DRM license request blob 405 may indicate the identity of the output device 301 as the device that generated the DRM license request blob 405 and/or may indicate the content 501. The output authorization token 503 may also indicate the output device 301 (e.g., by comprising the device identity token 409), the content item 501 (e.g., by comprising CKM metadata for the content item 501), the user device 302 (e.g., by comprising the device authentication token for the user device 302), and/or an account session for the user device 302 (e.g., by comprising the account session token). The DRM data request of step 354, which may comprise an HTTP POST method associated with a path (e.g., “/license”), may comprise additional data indicating the DRM service/platform associated with the content item 501, additional access indications, and/or other information.

Based on receiving the DRM license request of step 354, the DRM license service 307 may authenticate the output authorization token 503 and/or may process the DRM license request blob 405. The DRM license service 307 may determine, for both the DRM license request blob 405 and the output authorization token 503, whether the binding between the content item 501 and the device identity of the output device 301 is intact, and may further determine that the content item-device identity bindings from the DRM license request blob 405 and the output authorization token 503 are the same. If the output authorization token 503 is authentic, the DRM license request blob 405 is successfully processed, and/or the bindings are intact and the same, the DRM license service 307 may perform a content access check. The content access check may comprise sending, in step 356, an access authorization request to the content access service 308. The content access check of step 356 may provide information determined from the DRM license request of step 354 (e.g., indications of the content item 501, the output device 301, and/or a relevant account). Based on the information received in step 356, the content access service 308 may determine (e.g., by comparing the received information to account data in one or more databases) whether providing the content item 501 to the output device 301 conforms to usage, availability, and/or or rules. If the content access service 308 determines that accessing of the content item 501 by the output device 301 is authorized, an authorization response indicating authorized access may be sent to the DRM license service in step 358.

If the content access check fails (e.g., if an authorization response is not received from the content access service 308), or if the DRM license service 307 is unable to authenticate the output authorization token 503, process the DRM license request blob 405, confirm device-content bindings, or otherwise process the request of step 354, the DRM license service 307 may send a denial to the output device 301. Such a denial, which may include a code indicating the reason for denial, may cause the output device 301 and/or the user device 302 to cause output of a display indicating the denial, the reason for the denial, and/or corrective actions that may be taken.

If the DRM license service 307 is able to authenticate the output authorization token 503, process the DRM license request blob 405, confirm device-content bindings, and otherwise process the request of step 354, and if the content access service 308 in step 358 sends the DRM license service 307 an authorization response indicating access to the content item 501 is authorized, the DRM license service 307 may in step 360 send DRM data (e.g., a DRM license) to the output device 301. The DRM data may comprise authorization data that allows the output device 301 to process media data for the content item 501. The authorization data may comprise, for example one or more keys or other data that the output device may use to decrypt (e.g., unwrap) keys that may be used to decrypt encrypted media data for the content item 501. The DRM license sent in step 360 may be digitally signed and/or encrypted.

Based on receiving the DRM data in step 360, the output device 301 may in step 362 request media data (e.g., one or more encrypted fragments) for the content item 501 from the content delivery network 304. The output device 301 may send the request of step 362 using manifest data obtained in 332, and/or the output device 301 may request additional manifest data for the content item 501. In step 364, the output device 301 may, based on the request of step 362, receive media data for the content item 501. In step 366, the output device 301 may process the media data received in step 364. The processing of step 366 may comprise using the DRM data (received in step 360) to obtain decryption keys for the media data, using those obtained decryption keys to decrypt encrypted media data, and/or causing output (e.g., via a display screen and/or speakers of the output device 301 and/or of a computing device with which the output device 301 is in communication) of the content item 501 based on the decrypted media data. The steps 362 and 364 may be repeated during output of the content item 501 (e.g., the output device 301 may request and process media data for a first portion of the content item 501, request and process media data for a second portion of the content item 501, etc.). In connection with output of the content item 501 via the output device 301, and as shown as step 368, the user device 302 may send one or more commands, instructions, and/or other data that cause the output device 301 to stop, pause, rewind, fast-forward, of otherwise alter output of the content item 501.

As previously indicated, one or more steps and/or communications described in connection with FIGS. 3A-5 may be combined, omitted, performed in another order, performed by other computing devices, and/or otherwise modified. For example, the entitlement check of steps 340 and 342 may be combined with the content access check of steps 356 and 358. Moreover, the combined entitlement and content access check may be performed by the output authorization service 305 (e.g., in connection with processing a request for an output authorization token) and/or by the DRM license service 307 (e.g., in connection with processing a request for DRM data).

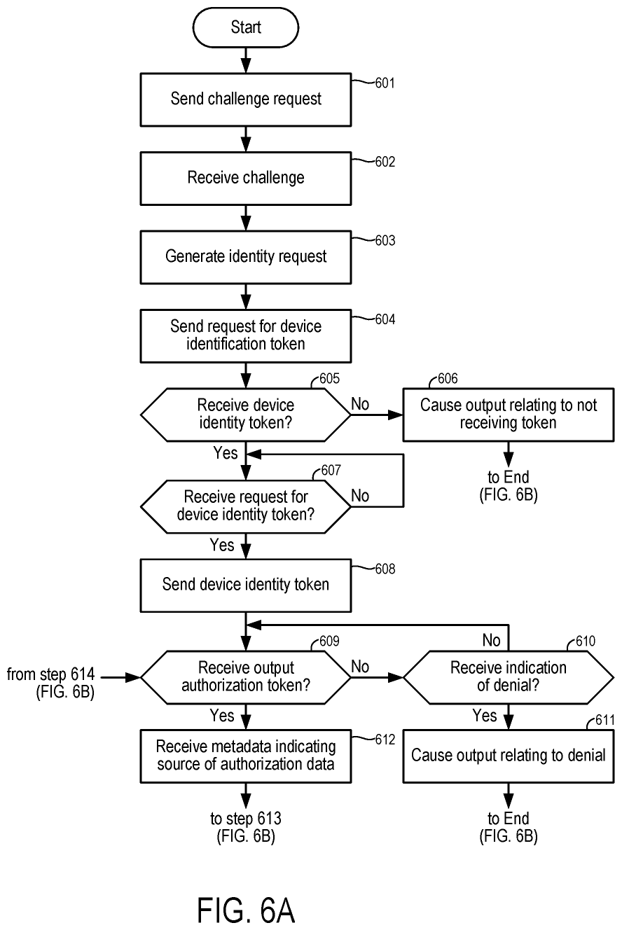

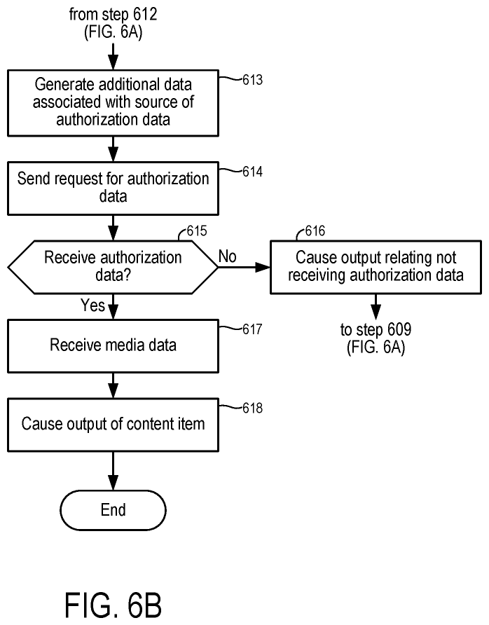

FIGS. 6A and 6B are a flow chart showing steps of an example method associated with output of a content item. One, some, or all steps of the example method of FIGS. 6A and 6B may be performed by an output device (e.g., the output device 301). Also or alternatively, one, some, or all steps of the example method of FIGS. 6A and 6B may be performed by one or more other computing devices. Steps of the example method of FIGS. 6A and 6B may be omitted, performed in other orders, and/or otherwise modified, and/or one or more additional steps may be added.

In step 601, the output device may send an identity challenge request. Step 601 may be similar to and/or may comprise (and/or be comprised by) step 314 of FIGS. 3A and 4. In step 602, the output device may receive an identity challenge. Step 602 may be similar to and/or may comprise (and/or be comprised by) step 316 of FIGS. 3A and 4.

In step 603, the output device may generate an identity request. Step 603 may be similar to and/or may comprise (and/or be comprised by) step 318 of FIGS. 3A and 4. The output device may generate the identity request using software that executes on the output device and that may be associated with a source of authorization data. The identity request may comprise data, generated by the software executing on the output device, that is associated with the output device and with the source of the authorization data. In step 604, the output device may send the identity request. Step 604 may be similar to and/or may comprise (and/or be comprised by) step 320 of FIGS. 3A and 4.

In step 605, the output device may determine whether a device has identity token has been received based on sending the request of step 604. If a device identity token is not received (e.g., if the output device receives an indication that the device identity token is denied, or if the request of step 604 has timed out), the output device may perform step 606 and cause output (e.g., via another computing device in communication with the output device) indicating that the device identity request failed, and/or may indicate corrective steps that may be performed. Based on performing step 606, the method of FIGS. 6A and 6B may end. If the output device determines in step 605 that a device identity token was received (e.g., if the output device has performed a step such as step 322 of FIGS. 3A and 4 and received a token such as the device identification token 409), step 607 may be performed.

In step 607, the output device may determine if it has received a request for the device identity token. If not, step 607 may be repeated. If a request for the device identity token has been received (e.g., if the output device has received a request such as the request of step 326 of FIGS. 3B and 5), step 608 may be performed. In step 608, the output device may, based on the request for the device identity token, send the device identity token (e.g., to a user device that sent the request). Step 608 may be similar to and/or may comprise (and/or be comprised by) step 328 of FIGS. 3B and 5.

In step 609, the output device may determine if an output authorization token has been received. If not, step 610 may be performed. In step 610, the output device may determine if data indicating a denial of an output authorization token (and/or reasons for such denial) has been received. If such data has been received, the output device may in step 611 cause output (e.g., via another computing device in communication with the output device) indicating the denial and/or corrective action. Based on step 611, the method may end. If the output device determines in step 610 that data has not been received, step 609 may be repeated. If the output device determines in step 609 that an output authorization token has been received (e.g., if the output device has received a token such as the output authorization token 503 received in step 346 of FIGS. 3B and 5), step 612 may be performed.

In step 612, and based on the received output authorization token, the output device may receive metadata associated with a content item and/or with a source of authorization data (e.g., DRM data) for the content item. The content item may be indicated by the output authorization token and/or by other data received with the output authorization token, and the output device may request the metadata, received in step 612, based on the indication of the content item by the output authorization token and/or by other data received with the authorization token. Step 612 may be similar to and/or may comprise (and/or may be comprised by) steps 348 and 350 of FIGS. 3B and 5.

In step 613 (FIG. 6B), the output device may generate data that is associated with the output device and with a source of authorization data for the content item for which metadata was received in step 612. The output device may generate the data in step 613 based on the metadata received in step 612 and/or using software, executing on the computing device, associated with the source of authorization data. Step 613 may be similar to and/or may comprise (and/or may be comprised by) step 352 of FIGS. 3B and 5.

In step 614, the output device may send a request for authorization data. The request of step 614 may comprise the output authorization token received in step 609 and/or the data generated in step 613. Step 614 may be similar to and/or may comprise (and/or may be comprised by) step 354 of FIGS. 3B and 5. In step 615, the payback device may determine if authorization data has been received based on the request of step 614. If not, the output device may in step 616 cause output (e.g., via another computing device in communication with the output device) indicating the reason authorization data has not been received (e.g., request was denied or timed out) and/or corrective action. Based on performing step 616, step 609 may be repeated (e.g., the output device may wait for a new output authorization token for the same content item, and/or for an output authorization token for another content item).

If the output device determines in step 615 that authorization data has been received (e.g., if the output device has received authorization data such as the DRM data sent in step 360 of FIGS. 3B and 5), step 617 may be performed. In step 617, the output device may receive media data for the content item for which the output authorization token was received in step 609. Step 617 may be similar to and/or may comprise (and/or be comprised by) steps 362 and 364 of FIGS. 3B and 5. In step 618, the output device may cause, by using the authorization data (determined in step 615 to have been received) to process the media data received in step 617, output of the content item. Step 618 may be similar to and/or may comprise (and/or be comprised by) step 366 of FIGS. 3B and 5.

An output device 300 may store authorization data (e.g., one or more DRM licenses) for multiple content items to avoid repeating steps of FIGS. 6A and/or 6B if attempting to access a previously accessed content item. For example, the output device may receive a DRM license to access content item A. If, during output of the content item A, a user device directs the output device to cause output a content item B, steps 612-614 and 615-618 (and/or other steps) may be performed to receive authorization data associated with the content item B and to cause output of the content item B. If the user device directs the output device to again cause output the content item A, the output device may access the stored authorization data associated with the content item A and cause output the content item A to avoid repeating steps 612-614.

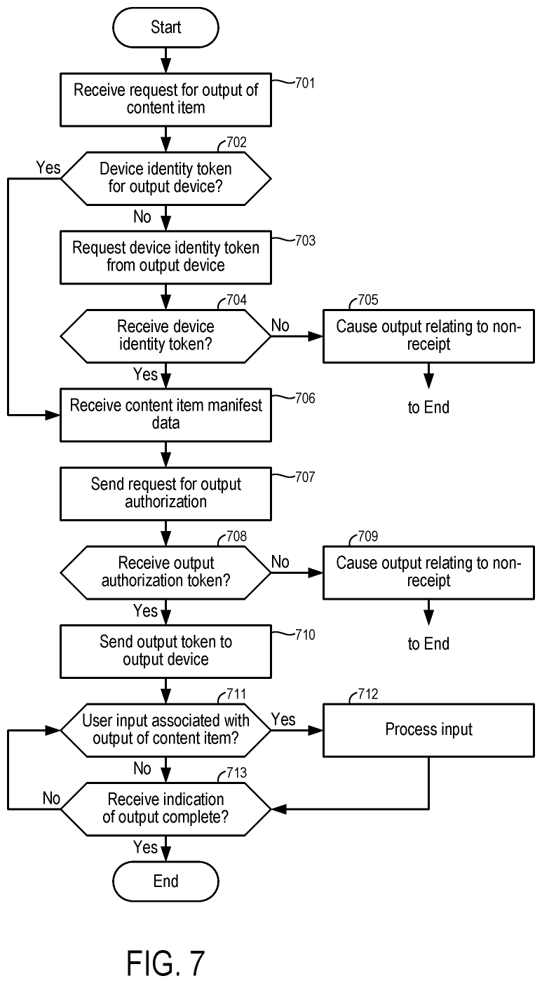

FIG. 7 is a flow chart showing steps of an example method associated with output of a content item. One, some, or all steps of the example method of FIG. 7 may be performed by a user device (e.g., the user device 302). Also or alternatively, one, some, or all steps of the example method of FIG. 7 may be performed by one or more other computing devices. Steps of the example method of FIG. 7 may be omitted, performed in other orders, and/or otherwise modified, and/or one or more additional steps may be added.

In step 701, a user device may receive a request for output of a content item via an output device. Step 701 may be similar to and/or may comprise (and/or be comprised by) step 324 of FIG. 3A. In step 702, the user device may determine if it has a device identity token for the output device. For example, a user device may store device identity tokens for multiple output devices (e.g., in a home network) and may use those device identity tokens, as needed, if content output via one of the multiple output devices is requested. If the user device has a device identity token for the output device associated with the request of step 701, step 706 may be performed (described below). Otherwise, step 703 may be performed.

In step 703 the user device may send, to the output device and based on the request received in step 701, a request for a device identity token. Step 703 may be similar to and/or may comprise (and/or be comprised by) step 326 of FIGS. 3A and 5. In step 704, the user device may determine if a device identity token has been received. If not, the user device may at step 705 cause output relating to not receiving the device identity token (e.g., a display of an indication of a time-out or error). Based on performing step 705, the method of FIG. 7 may end. If the user device determines in step 704 that a device identity token has been received (e.g., that a device identity token such as the device identity token 409 sent in step 328 of FIGS. 3A and 5 has been received), step 706 may be performed.

In step 706, the user device may receive a manifest and/or other metadata for the content item associated with the request of step 701. Step 706 may be similar to and/or may comprise (and/or be comprised by) steps 330 and 332 of FIGS. 3A and 5. In step 707, the user device may send a request for output authorization. The request for output authorization may comprise the device identification token and/or information indicating the content item. Step 707 may be similar to and/or may comprise (and/or be comprised by) step 334 of FIGS. 3A and 5.

In step 708, the user device may determine if an output authorization token has been received based on the request of step 707. If not, the user device may in step 709 cause output of information relating to non-receipt of the output authorization token (e.g., a display of an indication of a time-out or error, and/or an indication of a reason output authorization was denied). Based on performing step 709, the method of FIG. 7 may end. If the user device determines in step 708 that an output authorization token has been received (e.g., that an output authorization token such as the output authorization token 503 sent in step 344 of FIGS. 3B and 5 has been received), step 710 may be performed.

In step 710, and based on receiving the output authorization token, the user device may send the output authorization token to the output device. Step 710 may be similar to and/or may comprise (and/or be comprised by) step 346 of FIGS. 3B and 5. In step 711, the user device may determine if user input (e.g., via an application associated with the output device and executing on the user device) relating to output of the content item has been received (e.g., if a command or instruction such as in step 368 of FIG. 3B has been received). If so, the user device may process that input. Processing of that input may comprise determining an action relating to output (e.g., pause, rewind, fast-forward, end playback, etc.) and sending a command, instruction, or other data to the output device to cause the output device to perform the action.

Based on performing step 712, or based on determining in step 711 that a user input was not received, step 713 may be performed. In step 713, the user device may determine if output of the content item is complete (e.g., if the content item has been played back to completion or if the output was ended before completion). If not, step 711 may be repeated. If so, the method of FIG. 7 may end.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
sending, by an output device to a user device, a device identification token associated with the output device;
receiving, based on the sending the device identification token to the user device, an output authorization token associated with a content item and with the output device;
sending a request, comprising the output authorization token, for authorization data associated with output of the content item; and
causing, based on the authorization data, output of the content item.

2. The method of claim 1, further comprising:
sending, by the output device, a device identity request associated with the output device and with a source of the authorization data; and
receiving, based on the sending the device identity request, the device identity token.

3. The method of claim 1, wherein the sending the device identification token is based on a request, received from the user device, for the device identification token.

4. The method of claim 1, further comprising:
based on receiving the output authorization token, receiving metadata, associated with a source of the authorization data, and a manifest indicating data associated with the content item.

5. The method of claim 1, wherein the request further comprises a binary large object, based on metadata associated with the content item, associated with a source of the authorization data.

6. The method of claim 1, wherein the authorization data comprises digital rights management (DRM) data, and wherein the causing the output of the content item comprises decrypting, using the DRM data, a decryption key for decrypting data associated with the content item.

7. The method of claim 1, wherein the output device comprises a casting device in communication with a computing device different from the user device.

8. The method of claim 1, wherein the sending the request comprises sending the request to a computing device different from the user device.

9. The method of claim 1, further comprising:
receiving, by the output device from a content source different from the user device, data associated with the content item.

10. The method of claim 1, wherein the device identification token comprises:
a device identity associated with a source of the authorization data, and
a second device identity associated with a second source of second authorization data for a second content item.

11. The method of claim 1, wherein the output authorization token is further associated with one or more of:
the user device,
a user associated with the user device, or
an account associated with at least one of the user or the user device.

12. A method comprising:
sending, by an output device, a device identity request associated with a source of digital rights management (DRM) data for a content item;
receiving, based on the device identity request, a device identification token;
receiving, based on sending the device identification token to a user device, an output authorization token associated with a content item and with the output device;
sending, to a computing device associated with the source of DRM data, a DRM data request comprising the output authorization token; and
receiving, based on the DRM data request, the DRM data.

13. The method of claim 12, further comprising:
decrypting, using the DRM data, a decryption key for decrypting data associated with the content item;
causing, based on the decrypted decryption key, output of the content item.

14. The method of claim 12, wherein the output device comprises a casting device in communication with a computing device different from the user device.

15. The method of claim 12, wherein the output authorization token is further associated with one or more of:
the user device,
a user associated with the user device, or
an account associated with at least one of the user or the user device.

16. A method comprising:
receiving, by a user device, a first request for output of a content item via an output device;
sending, to the output device and based on the first request for output of the content item, a second request for a device identification token;
sending, to a computing device, a third request comprising the device identification token and information indicating the content item;
receiving, based on the third request, an output authorization token associated with the content item and the output device; and
sending the output authorization token to the output device.

17. The method of claim 16, wherein the output device comprises a casting device in communication with a computing device different from the user device.

18. The method of claim 16, wherein the third request further comprises information indicating one or more of:
the user device,
a user associated with the user device, or
an account associated with at least one of the user or the user device.

19. The method of claim 16, wherein the output authorization token is further associated with one or more of:
the user device,
a user associated with the user device, or
an account associated with at least one of the user or the user device.

20. The method of claim 16, wherein the second request comprises an indication of a source of authorization data associated with the content item.
